(19) United States
(12) Patent Application Publication
(10) Pub. No.: US 2006/0210453 A1
(43) Pub. Date: Sep. 21, 2006

(54) Flue gas purification device

(75) Inventors: Theo Risse, Werne (DE); Christian Moser, Essen (DE)

Correspondence Address: HARNESS, DICKEY & PIERCE, P.L.C., P.O. BOX 828, BLOOMFIELD HILLS, MI, 48303, US

(73) Assignee: Lurgi Lentjes AG

(21) Appl. No.: 11/287,001

(22) Filed: Nov. 23, 2005

(30) Foreign Application Priority Data
Mar. 18, 2005 (EP) 05005919.5

(51) Int. Cl. B01D 53/34

(52) U.S. Cl. 422/168

(57) ABSTRACT

A flue gas purification device comprising a scrubbing liquid sump (16), which comprises:

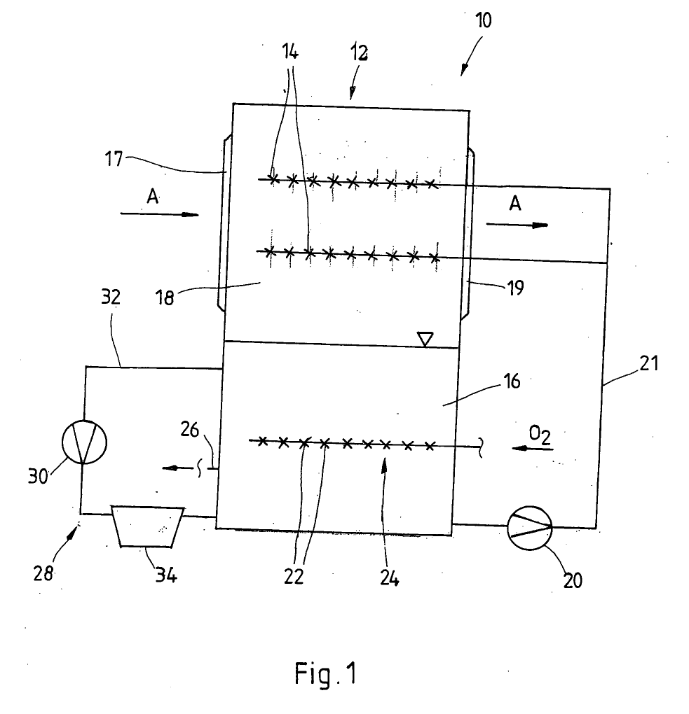

an oxidation device (24) having at least one pipeline (21) and oxygen outlets (22) provided therein for introducing oxygen into said scrubbing liquid sump (16), and

circulation means (28) for circulating the scrubbing liquid present in said scrubbing liquid sump (16) inside said scrubbing liquid sump (16),

characterized in that said oxygen outlets (22) of the at least one pipeline (21) of said oxidation device (24) have a diameter of least 9 mm.

The present invention relates to a flue gas purification device for purifying flue gas, in particular for desulfurizing exhaust gas of a coal power station or the like.

Such purification devices are already known in the state of the art. Normally they comprise a scrubbing column having scrubbing liquid nozzles, which are often arranged on several levels, a scrubbing liquid sump, in which scrubbing liquid is collected, and an absorption zone, which extends inside a receptacle of the scrubbing column from the scrubbing liquid sump towards the upper scrubbing liquid nozzle level. Flue gas is introduced into a lower section of the absorption zone in the scrubbing column, flows upwards from there and leaves the scrubbing column through an outlet provided above the scrubbing liquid nozzles. On its way through the scrubbing column, the flue gas gets into contact with scrubbing liquid emerging from the scrubbing liquid nozzles and is purified, which is described in detail in the following.

Such a purification device is for example known from DE-A-100 58 548. The scrubbing liquid preferably contains, apart from water, alkaline earths, which react with the sulphur oxides present in the flue gas and the sulphur oxides generated in the scrubbing column. Lime in form of calcium oxide, calcium hydroxide, calcium carbonate or the like is in particular used.

The alkaline earths react with the sulphur oxides present in the flue gas essentially to calcium sulphite, which is bound in the scrubbing liquid. In this manner, the flue gas is purified from the undesirable sulphur oxides and flows out of the purification device afterwards. However, the scrubbing liquid containing the calcium sulphite particles, which are kept floating in this one, flows into the scrubbing liquid sump and is collected there.

Calcium sulphate shall be won from the scrubbing liquid collected in the scrubbing liquid sump. Calcium sulphate has similar positive properties as natural gypsum and is mostly further processed to different materials, in particular construction materials.

In order to convert the calcium sulphite particles, which have been generated during the purification of the flue gas in the absorption zone of the scrubbing column, into calcium sulphate particles, it is known to provide an oxidation device in the scrubbing liquid sump, which introduces oxygen in form of air or the like into the scrubbing liquid sump. The reaction of oxygen and calcium sulphites generates calcium sulphate. In order to optimize this reaction, it is preferred that the oxidation device generates a high number of very small air bubbles (if possible with a diameter of <1 mm). Small air bubbles have the advantage that they have a longer residence time in the scrubbing liquid sump than big air bubbles, whereby the penetration of oxygen into the scrubbing liquid is improved. Furthermore, the reduction of the air bubble diameter and the increase of the number of bubbles lead to a larger contact surface between the oxygen bubbles and the scrubbing liquid and to a better oxygen exchange by means of diffusion and/or solution at the contact surfaces between the calcium sulphite particles and the oxygen bubbles. Finally, the prolonged residence time increases the way of the bubbles and thus the contact time.

However, the generation of very small oxygen bubbles has the disadvantage that the correspondingly small oxygen outlets of the oxidation device clog relatively fast, which increases the maintenance effort.

In order to prevent a clogging of such small oxygen outlets of the oxidation device, DE-A-43 29 427 proposes a scrubbing column for an installation of flue gas desulfurization, wherein flow insertions shall be placed in the scrubbing liquid sump of the scrubbing column and the pipelines with the oxygen outlets of the oxidation device shall be positioned in the region of the highest flow rate of the flow insertions. Due to the high flow rates at the oxygen outlets, a fast clogging of the oxygen outlets can be prevented. Furthermore, the increase of the flow rate also improves the reaction within the oxidation zone. However, a drawback is the mounting of the flow insertions, which requires a high effort.

It is an object of the present invention to provide a flue gas purification device, in which such flow insertions can be omitted, without the reaction within the oxidation zone, which has been improved by the small oxygen outlets and the flow insertions, being negatively affected.

This aim is achieved according to the present invention by a flue gas purification device comprising a scrubbing liquid sump, which comprises an oxidation device having at least one pipeline and oxygen outlets provided therein for introducing oxygen into the scrubbing liquid sump, and circulation means for circulating the scrubbing liquid present in the scrubbing liquid sump within the scrubbing liquid sump. Herein, the oxygen outlets of the at least one pipeline of the oxidation device have a diameter of least 9 mm according to the invention. Preferred are also 12 mm, and especially preferred are 15 mm.

In order to be able to omit the flow insertions used in the flue gas purification device according to DE-A43 29 427 and to simultaneously prevent a precipitate clogging of the oxygen outlets of the oxidation device, the oxygen outlets of the at least one pipeline of the oxidation device have a diameter of at least 9 mm according to the invention. Preferred are also 12 mm and 15 mm.

The drawbacks, which are caused by clogging, are negligible with such a great diameter. However, it is a drawback that the reaction in the oxidation zone of the scrubbing liquid sump is substantially worse in comparison to the known flue gas purification device. But it has been found, that this worsening of the reaction can be compensated, in that circulation means for circulating the scrubbing liquid present in the scrubbing liquid sump are placed inside the scrubbing liquid sump, since the flow rates inside the scrubbing liquid sump, which are generated by these circulation means, have a positive effect on the reaction within the oxidation zone. In comparison to the flow insertions, the circulation means have a very simple structure, since their simplest embodiment only consists of a pipeline having an inlet and outlet and of a corresponding pump. Furthermore, such circulation means have the advantage that the scrubbing liquid present in the scrubbing liquid sump is always well mixed and no deposits are formed at the bottom of the scrubbing liquid sump.

According to another embodiment of the present invention, the circulation means comprise an inlet, which is connected to the upper zone of the scrubbing liquid sump, outlet means, which are located in a lower zone of the scrubbing liquid sump, and a pump, the suction side of which is connected to the inlet and the delivery side of which is connected to the outlet means. In this way, scrubbing liquid is pumped from the upper zone of the scrubbing liquid sump into the lower zone and thus the scrubbing liquid in the lower zone is in particular mixed, so that no deposits of solids have to be expected at the bottom of the scrubbing liquid sump.

Furthermore, it is preferred that the at least one pipeline of the oxidation device is at least partially located on the circulation means, so that separate fixation means can be omitted.

Furthermore, the circulation means advantageously comprise a dosage device for admixing additives to the scrubbing liquid. In this way, the composition of the scrubbing liquid inside the scrubbing column can be adjusted as requested.

In the following, a preferred embodiment of the flue gas purification device is explained with reference to the annexed drawing. This one shows a sketchy front view of an embodiment of device 10 for the flue gas purification according to the invention. The flue gas is preferably flue gas from a coal power station or the like. Device 10 comprises a receptacle 12, which preferably is parallelepiped. In an upper zone of receptacle 12, scrubbing liquid nozzles 14 are placed, which can be arranged on different levels and be oriented in different directions, for example horizontally or vertically, wherein a horizontal orientation of the scrubbing liquid nozzles is preferred. In the lower part of receptacle 12, a scrubbing liquid sump 16 for receiving scrubbing liquid is provided. Between said scrubbing liquid nozzles 14 and said scrubbing liquid sump 16, receptacle 12 comprises an absorption zone 18, into which, in the operating state of device 10, flue gas to be purified is essentially introduced horizontally and with substantially constant speed in the direction of the arrows A via inlet 17 and flows out through outlet 19. Scrubbing liquid is pumped out of scrubbing liquid sump 16 by means of a pump device 20 via a pipe 21 to said scrubbing liquid nozzles 14 and is atomized by these ones in form of a fine mist onto the flue gas flowing through said absorption zone 18. The alkaline earths contained in the scrubbing liquid, such as for example calcium carbonate, react with the sulphur oxides in the flue gas, whereby calcium sulphite is essentially formed, which in turn is bound in the scrubbing liquid. In this way, the flue gas flowing through said absorption zone 18 is purified. The essentially horizontal flow of the flue gas through said absorption zone 18 has the advantage that a very uniform flow can be achieved, which in turn enables an improved sulphur oxide separation in said absorption zone 18.

The scrubbing liquid, which leaves said absorption zone 18 and which contains the calcium sulphites, is collected in said scrubbing liquid sump 16 and reacts there with oxygen that is introduced into said scrubbing liquid sump 16 via oxygen outlets 22 of an oxidation device 24, which is placed in said scrubbing liquid sump 16. These oxygen outlets 22 have a diameter of at least 9 mm, i.e. a diameter, which is large enough to prevent a clogging of said oxygen outlets 22. Due to the reaction, the calcium sulphites present in said scrubbing liquid sump 16 are oxidized to calcium sulphate. This one is finally pumped out of said scrubbing liquid sump 16, together with the scrubbing liquid, via outlet pipe 26 for further processing.

In order to improve the reaction, which takes place in the oxidation zone of said scrubbing liquid sump 16, circulation means 28 are provided, which essentially comprise a pipe 32 provided with a pump 30, through which scrubbing liquid is pumped from the upper part of said scrubbing liquid sump 16 into the lower part of said scrubbing liquid sump 16. In this way, a circulation of the scrubbing liquid is realized inside said scrubbing liquid sump 16, which leads to an improved reaction inside the oxidation zone. Furthermore, said circulation means 28 help to prevent the formation of solid deposits at the bottom of receptacle 12.

Finally, said circulation means 28 comprise a dosage device 34, by mans of which additives can be admixed to the scrubbing liquid flowing through pipe 32. However, it has to be pointed out that said dosage device 34 is optional.

The combination of said oxidation device 24, the pipes of which comprise oxygen outlets 22 having a diameter of more than 9 mm, and of said circulation means 28, which circulate the scrubbing liquid inside said scrubbing liquid sump 16, leads to a structure inside said scrubbing liquid sump 16, with which flow insertions can be omitted, wherein a clogging of said oxygen outlets 22 of said oxidation device 24 is prevented and a very good reaction inside the oxidation zone of said scrubbing liquid sump 16 is assured.

Finally it is to be noted that the device according to the invention can also be used for example for desalinization, in the cement industry or generally in power stations, which make use of fossil fuels.

It is to be understood that the above described, preferred embodiment is not limiting, but other modifications and variations are possible without leaving the protected scope of the present invention, which is defined by the annexed claims.

### LIST OF REFERENCE NUMBERALS

10 device
12 receptacle
14 scrubbing liquid nozzles
16 scrubbing liquid sump
17 inlet
18 absorption zone
19 outlet
20 pump device
21 pipe
22 oxygen outlet
24 oxidation device
26 outlet pipe
28 circulation means
30 pump
32 pipe
34 dosage device
A direction

1. A flue gas purification device comprising:
a scrubbing liquid sump including:
an oxidation device having at least one pipeline and oxygen outlets provided therein for introducing oxygen into said scrubbing liquid sump;
a circulation device for circulating the scrubbing liquid present in said scrubbing liquid sump inside said scrubbing liquid sump; and
wherein said oxygen outlets of the at least one pipeline of said oxidation device have a diameter of least 9 mm.

2. A flue gas purification device according to claim 1, wherein said circulation device comprises an inlet, which is connected to the upper zone of said scrubbing liquid sump, an outlet located in a lower zone of said scrubbing liquid sump, and a pump, the suction side of which is connected to the inlet and the delivery side of which is connected to the outlet.

3. A flue gas purification device according to claim 2, wherein the at least one pipeline of said oxidation device is at least partially located on said circulation device.

4. A flue gas purification device according to claim 3, wherein said circulation device further comprises a dosage device for admixing additives to the scrubbing liquid.
